(19) United States
(12) Patent Application Publication
(10) Pub. No.: US 2006/0223947 A1
(43) Pub. Date: Oct. 5, 2006

(54) Chemical synthesis of polymeric nanomaterials and carbon nanomaterials

(75) Inventors: Susan V. Olesik, Dublin, OH (US); Lunhan Ding, Columbus, OH (US)

Correspondence Address: CALFEE HALTER & GRISWOLD, LLP, 800 SUPERIOR AVENUE, SUITE 1400, CLEVELAND, OH, 44114, US

(73) Assignee: The Ohio State University Research Foundation, Columbus, OH (US)

(21) Appl. No.: 11/398,319

(22) Filed: Apr. 5, 2006

Related U.S. Application Data
(60) Provisional application No. 60/668,476, filed on Apr. 5, 2005.
(60) Provisional application No. 60/668,382, filed on Apr. 5, 2005.

(51) Int. Cl. C08F 38/00

(52) U.S. Cl. 525/328.1

(57) ABSTRACT

A high yield method for chemically synthesizing low polydispersivity carbon microspheres, nanospheres, nanocrystals, nanotubes, or nanofibers comprising dispersing a self-polymerizing end-capped polyyne in a solvent; heating the dispersed self-polymerizing end-capped tetrayne to form a polymeric material selected from the group consisting of polymer microspheres, polymer nanospheres, polymer nanocrystals, polymer nanotubes, and polymer nanofibers; and pyrolyzing the polymeric material to form a carbon material selected from the group consisting of carbon microspheres, carbon nanospheres, carbon nanocrystals carbon nanotubes, and carbon nanofibers, wherein the polydispersivity is less than 2.

### CROSS-REFERENCE TO RELATED APPLICATIONS

This application claims priority to U.S. Provisional Application Ser. No. 60/668,476, titled CHEMICAL SYNTHESIS OF CARBON MICROBEADS THROUGH OCTATETRAYNES, filed Apr. 5, 2005 and U.S. Provisional Application Ser. No. 60/668,382, titled SYNTHESIS OF POLYMER NANOSPHERES AND CARBON NANOSPHERES USING MONOMER 1,8-DIHYDROXYL-1,3,5,7-OCTATETRAYNES filed Apr. 5, 2005. The entirety of each of these provisional applications is incorporated herein by reference.

### STATEMENT ON FEDERALLY FUNDED RESEARCH

This invention was funded, at least in part, by National Science Foundation grant CHE-021 3529. The government may have certain rights in this invention.

### BACKGROUND OF THE INVENTION

Many approaches for preparing polymer nanospheres have been developed in recent years. These can be categorized into three categories according to preparation methods: (1) emulsion polymerization or micro-emulsion polymerization; (2) self-assembly of linear block copolymers; (3) intramolecular crosslinking of single-polymer chains.

Interest in carbon nanomaterials stems from their potential applications in the areas of lithium batteries, catalyst supports, fuel cell electrodes, electrode materials for supercapacitors, gas storage media, and nanocomposites. Carbon nanomaterials including fullerenes, carbon nanotubes, carbon onions, and carbon nanocages are mostly synthesized in low yield by electric-arc discharge, laser vaporization, which usually occurs under high vacuum. Some chemical routes have also been attempted. However, most of the chemical reactions are complicated and uncontrollable. Diamond-like carbon was synthesized by the reduction of an appropriate RCX₃ with K—Na alloy, but no carbon nanostructures were formed in the reactions. Catalytic chemical vapor deposition (CVD) and scrolling mechanism seem to be successful for the production of carbon nanotubes. Template syntheses have also been used to synthesize hollow carbon spheres and carbon nanotubes. Beadlike carbon nanostructures have been observed in the products of CVD at the early stage; however, the products are often heterogeneous and often contained the metallic catalysts. To the best of our knowledge, there have been no highly successful reports on preparation of carbon nanospheres.

Carbon microspheres are useful materials in many fields including lithium battery anodes, column packing materials for separation science, absorbents with high surface area, catalyst supports, high performance carbon artifacts and so on. Carbon microspheres are mostly prepared form various pitches. Typically coal tar or petroleum pitch is heated at about 300° C. to produce mesophase spheres in the isotropic matrix. Before extensive growth and aggregation of the spheres, the carbonization is quenched and spheres are separated as solids from soluble pitch by extraction with a proper solvent. The yield of carbon microspheres is around 5-10%. A specific name, Meso-Carbon Microbeads (MCMB), was given to the spheres prepared by this method. Although heat treatments of pitches have made quite success in the production of MCMB, the drawbacks of this method are also very apparent, such as very low bead yield, tedious extraction, and no proper way to control bead size.

Accordingly, a need exists for a method for producing carbon nanoparticles, including nano-spheres, nanotubes, nanofibers, nanocrystals, and molecularly thin polymeric films in high yields. The method should allow control over the size and size distribution of the nano-particles, with low polydispersivity and should provide carbon nano-spheres having an inert surface and well-controlled, very small size. Additionally, there exists a need for new methods for preparing carbon microbeads, which has a higher bead yields, with great control over bead size.

### SUMMARY OF THE INVENTION

Provided herein is a micro or nano polymeric material formed from a polymerized oligoyne, polyyne or mixture thereof. Further provided is a method for making a polymeric nanomaterial having the steps of dispersing a self-polymerizable monomer selected from the group consisting of an oligoyne, a polyyne or mixtures thereof in a solvent; and causing the self-polymerizable monomer to polymerize thereby forming the polymeric nanomaterial. Further provided is a method for forming carbon nanomaterials from the polymer nanomaterials by including the final step of pyrolizing the polymer nanomaterial to yield a carbon nanomaterial.

Also provided are methods for preparing a molecularly organized layer on a surface by first contacting a surface with a self-assembling, self-polymerizable monomer; and then polymerizing the self-assembling, self-polymerizable monomer to form a polymeric film that is molecularly thin.

Also provided is a method for preparing polymer microbeads by dispersing a self-polymerizable liquid end-capped tetrayne in a solvent; and heating the self-polymerizable end-capped tetrayne to a temperature sufficient to form polymeric microbeads.

Additionally, provided is a high yield method for chemically synthesizing low polydispersivity carbon microspheres, nanospheres, nanocrystals, nanotubes, or nanofibers comprising dispersing a self-polymerizing end-capped tetrayne in a solvent; heating the dispersed self-polymerizing end-capped tetrayne to form a polymeric material selected from the group consisting of polymer microspheres, polymer nanospheres, polymer nanocrystals, polymer nanotubes, and polymer nanofibers; and pyrolyzing the polymeric material to form a carbon material selected from the group consisting of carbon microspheres, carbon nanospheres, carbon nanocrystals carbon nanotubes, and carbon nanofibers; wherein the polydispersivity of the carbon material is in the range from 1 to 2.

### BRIEF DESCRIPTION OF THE FIGURES

FIG. 1 illustrates the diversity of structure possible by polymerizing 1,8-dihydroxymethyl-1,3,5,7-octatetrayne.

FIG. 2 shows the IR spectra of 1,8-dihydroxymethyl-1,3,5,7-octatetrayne and its polymerized products.

FIG. 3 shows an HRSEM micrograph of poly(1,8-dihydroxymethyl-1,3,5,7-octatetrayne)

FIG. 4 shows a Power X-ray diffraction spectrum of poly(1,8-dihydroxymethyl-1,3,5,7-octatetrayne) ultrathin films.

FIG. 5 shows the formation of poly(1,8-dihydroxymethyl-1,3,5,7-octatetrayne) ultrathin films.

FIG. 6 shows HRSEM micrographs of poly(1,8-dihydroxymethyl-1,3,5,7-octatetrayne) nanospheres prepared with addition of phenyltrimethylamine chloride (0.04%, wt.) at the concentrations of 1,8-dihydroxymethyl-1,3,5,7-octatetrayne: a) 0.1%, b) 0.2%, c) 0.3%, d) 0.4%

FIG. 7 shows carbon nanospheres prepared from the correspondent poly(1,8-dihydroxymethyl-1,3,5,7-octatetrayne) nanospheres; the image background is Pd—Au alloy coating on glass slide.

FIG. 8 shows the Raman spectra of poly(1,8-dihydroxymethyl-1,3,5,7-octatetrayne) nanospheres and its corresponding carbon nanospheres.

FIG. 9 shows triple bond additions and cyclization in the polymerization of 1,8-dibutyl-1,3,5,7-octatetrayne.

FIG. 10 depicts SEM micrographs of poly(dibutyloctatetrayne) beads prepared by the methods described herein.

FIG. 11 depicts SEM micrographs of carbon microbeads prepared by the methods described herein.

FIG. 12 shows Raman spectra of poly(dibutyloctatetrayne) microbeads and its carbonized products.

FIG. 13 shows X-ray diffraction patterns of the carbon microbeads and commercial graphite.

FIG. 14 shows the C1s and O1s high-resolution XPS spectra for poly(dibutyloctatetrayne) microbeads and carbon microbeads.

FIG. 15. Image of poly(5,7,9,11 hexadecatetraydoic acid, HDTDA) crystals

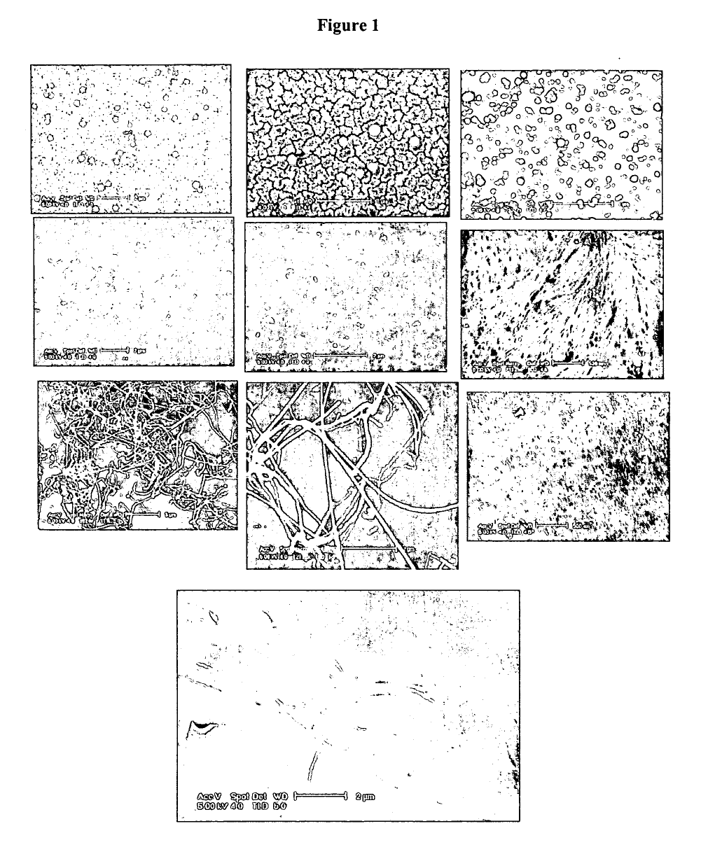

### DETAILED DESCRIPTION OF THE INVENTION

Linear conjugated oligoynes, —(C≡C)ₓ—, are interesting compounds in carbon chemistry. As one form of carbon, all-carbon oligoyne molecules are assumed to be the intermediates in the growth of carbon nanotubes and fullerenes. Oligynes higher than ethyne are very reactive (even explosive), and thus are not available under usual conditions. The high reactivity of oligoynes can be lowered by end-capping with suitable end-groups, like R₃Si—, alkyl, alkyl hydroxyl, carboxylic acids, and other stable groups. Due to long-scale conjugated triple bonds, end-capped oligoynes are still reactive at relatively vigorous conditions such as higher temperature or UV irradiation, and consequently intermolecular crosslinking and carbon-like structures can be formed. Pyrolysis of the crosslinked products at high temperature will leave the carbon structures while volatizing the protected groups in molecules. This behavior provides the possibility to prepare various polymeric and carbon structures using end-capped oligoynes as reactive precursors.

In one embodiment, a method of preparing highly crosslinked and surface-functionalized polymer nanomaterials by using molecularly organized, or self-assembling, self-polymerizable monomers is provided. The monomers used, end-capped tetraynes, can both self-assemble and self-polymerize. By changing the end-capping units, one can readily produce different shaped polymeric nanomaterials, and thus different shaped carbon nanomaterials. Some different forms that may be produced include, but are not limited to microspheres, nanospheres, nanotubes, fibers, molecularly thin films and nanocrystals. The resulting carbon nanomaterials, or carbon micromaterials, are produced in higher yields and with much better polydispersivity than can otherwise be achieved.

For preparing nanomaterials, the end-capping units may be selected from alkyl, alkyl hydroxyl, carboxylic acids, as well as other polar groups. In some embodiments, the end-capping units are selected from methyl, ethyl, propyl, butyl, pentyl, methyl hydroxyl, ethyl hydroxyl, propyl hydroxyl, and so forth, and combinations thereof. By choosing an amphiphilic end capping unit, the particles formed will form on a nanoscale size, as a nanosphere, nanofiber, molecularly thin film, for example; by choosing non-polar end groups, the particles formed will form on a microscale size. To form nanocrystalline polymers, the end-capping units chosen are carboxylic acids. The tetrayne may be an octatrayne or a longer tetrayne. In one embodiment of preparing microspheres, the end-capped tetrayhe is 1,8-dibutyl-1,3,5,7-octatetrayne. In another embodiment nanospheres, nanofibers and molecularly thin films are formed using the monomer 1,8-dihydroxymethyl-1,3,5,7-octatetrayne. In another embodiment, polymer nanocrystals are formed by polymerizing the sodium salt of 5,7,9,11-hexadecatetraydioic acid using the method described herein. The methods provided herein allow for synthesis of various crosslinked structures by using various functional groups, surfactants, or other mechanisms prior to crosslinking. By changing the reaction conditions, such as by adding a surfactant during formation of the nanoparticles, even greater control over size may be achieved.

The method of prerparing polymer nanomaterials comprises the steps of dispersing the end-capped tetrayne or other end-capped polyyne in a solvent and polymerizing the end-capped tetrayne at a sufficient temperature to yield the polymer nano-spheres. In certain embodiments, a surfactant, such as phenyltrimethylamine hydroxide, is added to help disperse the end-capped tetrayne. Conveniently, aqueous solvents may be used. The temperatures used for the polymerization step are generally between about 60° and 70° C., though it should be understood that higher or lower temperatures may be used depending on the monomer, end-capping units, or other factors. In other embodiments, the polymerization temperature may be between 50° and 80° C. In different embodiments, the polymerization temperature may be about 50°, about 60°, about 70°, or about 80° C. In still other embodiments, the polymerization temperature may be about 50, about 65°, about 75°, or about 85° C. The polydispersivity of the resulting polymer nanomaterials and carbon nanomaterials is in the range from 1 to 2, without the need for an additional separation step. Polydispersivities of the materials as prepared are generally within the range from between about 1.25 and about 1.75. In some embodiements, the polydispersivity is in the range from about 1.45 to about 1.65. In other embodiments, the polydispersivity is in the range from about 1.25 to about 1.85. In still other embodiments, the polydispersivity is in the range from about 1.45 to about 1.70.

To form carbon materials from the polymeric materials, the polymeric materials are pyrolized. The additional step of pyrolizing the polymer nano-spheres at a sufficient temperature for a sufficient period of time to yield the carbon nanospheres. Temperatures of up to about 800° C. may be used in the pyrolysis step.

The method provided herein allows for synthesis of various crosslinked structures by using various functional groups, surfactants, or other mechanisms prior to crosslinking. Also provided is a synthetic method for forming carbon nano-spheres from the polymer nano-spheres described herein. Further provided are applications using the nano-particles described herein.

1,8-dihydroxymethyl-1,3,5,7-octatetrayne belongs to a special type of carbon allotropes-oligoynes or polyynes containing a carbon chain with alternating single bond (1.58 Å) and triple bond (1.20 Å). Oligoynes without end-capped groups are extremely reactive. For example, oligoynes, such as butadiyne, hexadiyne, octatetrayne, dedecahexayne, can spontaneously be polymerized in their diluted solutions at room temperature or at refrigerated temperatures, toward carbonaceous materials. The high reactivity of oligoynes can be suppressed by end-capping with protective groups. As a result, linear polyynes containing up to 300 carbon atoms capped by —CF₃ or —CN groups have been prepared and shown their stabilities under usual conditions. On the other hand, end-capped oligoynes may be moderately reactive compounds due to the long-scale conjugated triple bonds existing in their structures.

Under certain conditions, e.g., a moderate temperature or UV irradiation, oligoynes capped with protecting groups tend to combine with each other and form intermolecular crosslinking as well as carbonaceous structures. The moderate reactivity of end-capped oligoynes makes it possible to pre-organize oligoyne molecules with the assistance of functional groups or surfactants or other mechanisms prior to crosslinking reactions and preserve the structures in the course of crosslinking reactions. Therefore, various crosslinked polymer structures may be obtained. Using the methods described herein, 1,8-dihydroxymethyl-1,3,5,7-octatetrayne is first dispersed in water as nano-droplets either using only the aqueous solvent or with the assistance of a surfactant. The nano-droplets are then polymerized into poly(1,8-dihydroxylmethyl-1,3,5,7-octatetrayne) nano-spheres with high amount of hydroxyl groups on the surfaces.

The amphiphilic and self-polymerizable monomer 1,8,-dihydroxylmethyl-1,3,5,7-octatetrayne was prepared and dispered in water by itself or with the help of phenyltrimethylamine hydroxide. Crosslinked poly(1,8,-dihydroxylmethyl-1,3,5,7-octatetrayne) non-spheres were produced due to spontaneous polymerization of octatetrayne structures. XPS demonstrated the presence of a large amount of hydroxyl groups on the surface of poly(1,8-dihydroxymethyl-1,3,5,7-octatetrayne) nano-spheres. Carbon nano-spheres may be generated by pyrolysis of crosslinked poly(1,8-dihydroxymethyl-1,3,5,7-octatetrayne) nano-spheres at high temperatures in inert atmospheres in the yield of 60%. It is understood by those skilled in the art that while the synthesis of octatetraynes is disclosed herein, end-capped tetraynes do not have to be prepared as part of the method of making the polymer nanomaterials described herein. The end-capped tetraynes may be prepared in advance, purchased, and so forth.

The chemical synthesis yields polymeric nanomaterials, including nano-spheres, nanofibers, nanocrystals, and films, and ultimately cabon nanomaterials having an inert structure and very small, well-controlled size. Through the use of functional groups or surfactants prior to the crosslinking reactions, various crosslinked polymeric structures may be prepared.

The polymeric nano-spheres and carbon nano-spheres synthesized using the methods described herein may be used in many different applications, including but not limited to lithium batteries, catalyst supports, fuel cell electrodes, electrode materials for supercapacitors, gas storage media, nanocomposites, analytical applications, polymer reinforcements, and remediation of pollutants in water.

The chemical synthetic route for preparing polymer nanomaterials and carbon nanomaterials may also be applied to preparing microparticles and carbon microparticles using end-capped linear conjugated oligoynes, specifically tetraynes. The method for preparing the carbon microparticles, such as carbon microbeads comprises the steps polymerization of a self-polymerizable liquid end-capped tetrayne at a sufficient temperature to form polymeric microbeads and then pyrolizing the microbeads to form carbon microbeads. In one embodiment, the tetrayne is octatetrayne. The tetraynes used in the methods described herein are end-capped, the end-groups selected from the group selected from alkyl and R₃Si—, wherein R is selected from the group consisting H, lower alkyl and combinations thereof. In embodiments wherein the end-capping groups are alkyl, they may be selected from any short alkyl, such as ethyl, methyl, propyl, butyl, and so forth. In one embodiment, the tetrayne is 1,8-dibutyl-1,3,5,7-octatetrayne. In other embodiments, other tetraynes of other lengths, having other functional groups may be used.

The microbeads provided herein are especially useful in lithium battery anodes, column packing materials for separation science, absorbents with high surface area (water treatment applications), catalyst supports, and high performance carbon artifacts comprising the carbon microbeads described herein.

The method described herein is a chemical synthesis of carbon microspheres via suspension polymerization of a liquid tetrayne, followed by pyrolysis of crosslinked poly(tetrayne) microspheres. In this process, no extraction was involved, and the bead size may be controlled by the amount of the stabilizers used as well as the stir speed. The diameter of bead is adjustable in the range from over 100 micrometers to 1 micron with a polydispersivity in the range between 1 and 2. Polydispersivities of the materials as prepared are generally within the range from between about 1.25 and about 1.75. In some embodiements, the polydispersivity is in the range from about 1.45 to about 1.65. In other embodiments, the polydispersivity is in the range from about 1.25 to about 1.85. In still other embodiments, the polydispersivity is in the range from about 1.45 to about 1.70.

The method of preparing microparticles uses end-capped linear conjugated oligoynes, specifically tetraynes, and comprises the steps polymerization of a self-polymerizable liquid end-capped tetrayne at a sufficient temperature to form polymeric microbeads and then pyrolizing the microbeads to form carbon microbeads. In one embodiment, the tetrayne is octatetrayne. The tetraynes used in the methods described herein are end-capped, the end-groups selected from the group selected from alkyl and R₃Si—, wherein R is selected from the group consisting H, lower alkyl, and combinations thereof. In embodiments wherein the end-capping groups are alkyl, they may be selected from any short alkyl, such as ethyl, methyl, propyl, butyl, and so forth. To prepare polymer microbeads and carbon microbeads, the end-capping units are selected to be non-polar.

In some embodiments, the tetrayne is 1,8-dibutyl-1,3,5,7-octatetrayne. In other embodiments, other tetraynes of other lengths, having other functional groups may be used. In embodiments wherein a tetrayne longer than an octatetrayne is used, the method described herein may be used; the temperature for polymerization, however, will decrease as the length of the tetrayne increases.

Briefly, a liquid octatetrayne was prepared and polymerized at a temperature above 70° C. via suspension polymerization using water as the continuous phase and poly(vinyl alcohol) as the stabilizer to give crosslinked spherical polymers. The microbeads of polyoctatetrayne were then converted to carbon microspheres at 800° C. under nitrogen atmosphere. The resultant carbon products were examined by SEM, Raman spectroscopy, XPS, and X-ray WADS.

The methods decribed herein are useful in the preparation of carbon microbeads in relatively high yields, while being able to control the size and the size distribution of the microbeads. The microbeads may be prepared in sizes ranging from several micrometers to hundreds of micrometers. By varying the conditions, carbon microtubes may be prepared using the same starting materials.

### EXAMPLE 1

Preparation of Polymeric Nano-Spheres Materials. 1-iodo-2-(trimethylsilyl)acetylene, propargyl alcohol, bis(triphenylphosphine)palladium (II) dichloride, copper(I) iodide, copper(II) acetate monohydrate, N,N,N,N,-tetramethyl ehtylenediamine (TMEDA), diisopropylamine were used as received from Aldrich.

Preparation of 1-hydroxymethyl-4-(trimethylsilyl)-1,3-butadiyne To 250 mLof diisopropylamine were added bis(triphenylphosphine)palladium (II) dichloride (0.25 g, 0.356 mmol), copper(I) iodided (0.068 g, 0.356 mmol). The mixture was stirred and degassed with a stream of argon and a mixture of 1-iodo-2-(trimethylsilyl)acetylene (4.0 g, 17.8 mmol) and propargyl alcohol (1.20 g, 21.36 mmol) were added. The solution was stirred at room temperature for 2.0 h and a heavy precipitation was formed during this period of time. The reaction mixture was filtered to remove salts. The filtrate was concentrated with a rotarty evaporator under vacuum and the oily residue was obtained. The crude product was purified by passing it through a silica gel column with 20% acetate/hexane as eluant. The pure product was obtained as a yellow liquid at the yield of 73% (1.98 g). ¹H NMR (250 MHz CDCl₃): δ 0.18(9H), 1.67(1H), 4.31(2H). ¹³C NMR (63 MHz, CDCl₃): δ 0.00, 50.39, 66.04, 68.63, 69.76, 78.24.

Preparation of 1-hydroxymethyl-1,3-butadiyne To a solution of 1-hydroxymethyl-4-(trimethylsilyl)-1,3-butadiyne (2.0 g, 13.1 mmol) preparared above in methanol (25 mL) was added 5% aqueous solution of potassium hydroxide (0.86 mL). The solution was stirred at room temperature for 2 h. The reaction mixture was diluted with equal volumes of water and extracted with ether (4×30 mL). The combined organic layers were dried over MgSO₄ and the solvent was removed under reduced pressure to yield a yellow liquid. The product was purified by silica gel column chromatography with 20% acetate/hexane as the eluent and yielded 1-hydroxymethyl-1,3-butadiyne as a yellow liquid. (0.88 g, 84%). ¹H NMR (250 MHz CDCl₃): δ 2.04(1H), 3.62(1H), 4.36(2H). ¹³C NMR (63 MHz, CDCl₃): δ 0.00, 50.95, 67.74, 68.58, 69.55, 75.19.

Preparation of 1,8-dihydroxymethyl-1,3,5,7-octatetrayne A solution of acetone (50 mL), TMEDA (0.12 g, 1.0 mmol), copper(II) acetate monohydrate (0.095 g, 0.05 mmol) was stirred at room temperature. The air was introduced into the solution with an inlet tube immersed in the solution. To the solution 1-hydroxymethyl-1,3-butadiyne (0.80 g, 10.00 mmol) was added. The reaction mixture was stirred at room temperature for about 40 min. until TLC indicated reaction was completed. The reaction mixture was poured into a beaker containing both 5% HCl aqueous solution (30 mL) and acetate (50 mL). The organic layer was collected and the aqueous solution was extracted with acetate (3×40 mL). The combined organic layers were dried over MgSO₄ and concentrated under reduced pressure leaving a yellow liquid as the crude product. The crude product was purified using a silica gel column with 50% acetate/hexane as the eluant and yielded 1,8-dihydroxylmethylocatatetrayne as a yellow liquid (0.67 g, 85%). ¹H NMR (250 MHz DMSO-d₆): δ 4.11(4H), 5.44(2H). ¹³C NMR (63 MHz, DMSO-d₆): δ 50.40, 62.70, 63.06, 68.71, 81.94.

Polymerization of 1,8-dihydroxymethyl-1,3,5,7-octatetrayne An aqueous solution of phenyltrimethyl amine hydroxide (0.04% wt., 200 mL) was stirred at room temperature. To the solution was gradually added 6.0 g of 1,8-dihydroxymehyl-1,3,5,7-octatetrayne in THF (3.5% wt.) The mixture was placed in a 70° C. oil bath and stirred vigorously for 24 h. Crosslinked poly(1,8-dihydroxymethyl-1,3,5,7-octatetrayne) nano-spheres in aqueous solution were obtained. The product solution was concentrated with rotary evaporation under vacuum. The product solution was rinsed with ethanol and dried in vacuum to yield solid poly(1,8-dihydroxymethyl-1,3,5,7-octatetrayne) nano-spheres (0.17 g, 84%).

### EXAMPLE 2

Preparation of Carbon Nano-Spheres The crosslinked poly(dihydroxymethyloctatetrayne) nano-spheres (0.20 g) prepared above were placed in a quartz tube furnace and heated to 150° C. (rate 1° C./min.) under an argon atmosphere and held at 150° C. for 12 h. The furnace temperature was then increased to 800° C. (rate 1° C./min.) and fixed at 800° C. for 24 h. After cooling to room temperature, 0.12 g (60%) of carbon nanospheres was obtained from the quartz plate.

### EXAMPLE 3

Analysis of the Nanospheres All NMR spectra were recorded on an Bruker AC-200 spectrometer. FTIR spectra were obtained with a Perkin-Elmer 1600 FTIR spectrometer. The samples and KBr were thoroughly mixed and the mixture was pressed to form a pellet, then the spectra were recorded. Raman spectra were recorded with a Spex 1403 double monochromator, a RCA 31034A photomultiplier, and 514.5 nm laser with ca. 50 mW. Scanning electron micrographs were obtained on Sirion high-resolution scanning electron microscope operating at 5 kV. Poly 1,8-dihydroxymethyl-1,3,5,7-octatetrayne (DHMOTY) samples were placed on glass slides and coated with Pd-Au-alloy prior to SEM examination. Carbon nanospheres were dispersed in hexane and one drop of the dilute suspension was deposited on a small piece of heavily Pd/Au-alloy-coated glass slide. Because carbon nanospheres are electrically conductive, no gold-coating was needed for SEM examination. Number average particle diameters (Dn), weight average particle diameters (Dw), and the polydispersity index of particle size distribution (PSD, Dw/Dn) were determined based on the measurement of more than 100 particles in SEM images. TGA analyses were carried out on a TA Instruments TGA 2050 thermogravimetric analyzer. XPS was conducted on a Kratos AXIS ultra XPS spectrometer. The XPS data were processed using Kratos Vision processing. Powder X-ray diffraction was conducted on a Rigaku Geigerflex X-ray powder diffractometer with a copper KR line (0.154 nm) as the incident beam.

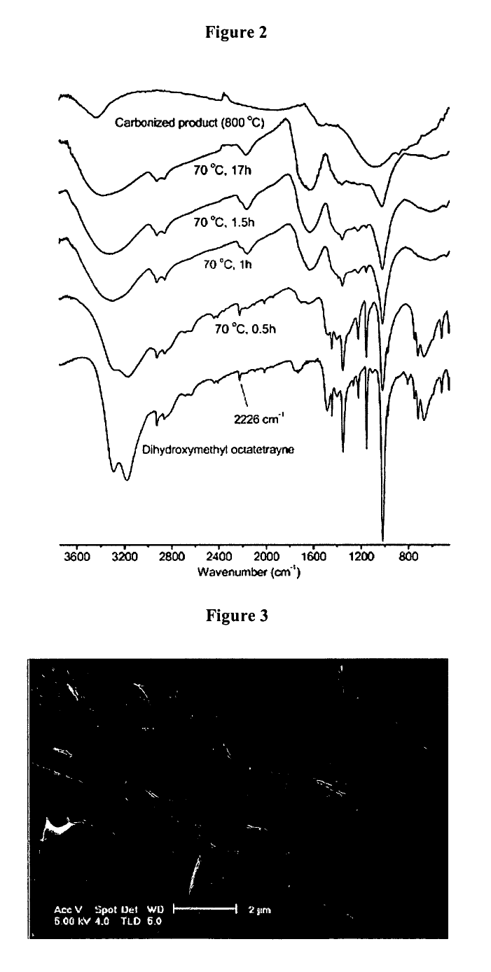

DHMOTY was prepared according to the synthetic route in Scheme 1. Due to four conjugated triple bonds in the molecule, DHMOTY is a very reactive compound. In many cases, molecules of DHMOTY tend to combine with each other and form cross-linked polymers. This behavior is reflected by changes in the infrared spectra of DHMOTY when heated at 70° C. FIG. 2 shows the intensity of the peak at 2226 cm⁻¹, which corresponds to the —CtC— structural backbone stretching vibration, decreases, and almost disappears as the reaction time increases. The same phenomena occurred to the bands between 810 cm⁻¹ to 450 cm⁻¹, which also are associated with carbon-carbon triple bonds. Therefore, it can be concluded that most of sp¹-hybridized carbon atoms in the molecule of DHMOTY were converted to sp²-hybridized carbon atoms and form graphite-like structures by various triple bond addition and cyclization reactions that usually occur in the polymerization of oligoynes.³¹ Due to those reactions, DHMOTY was converted into cross-linked polymer product.

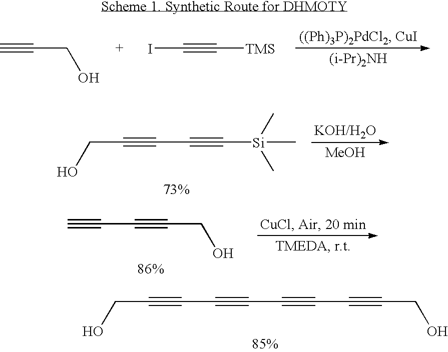

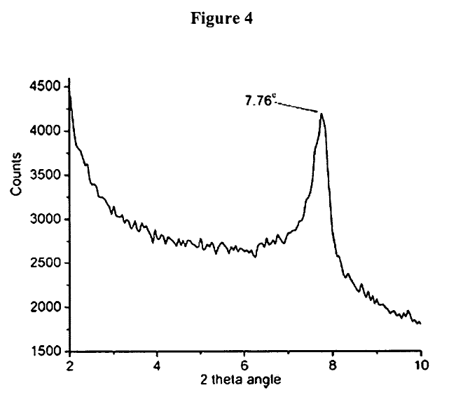

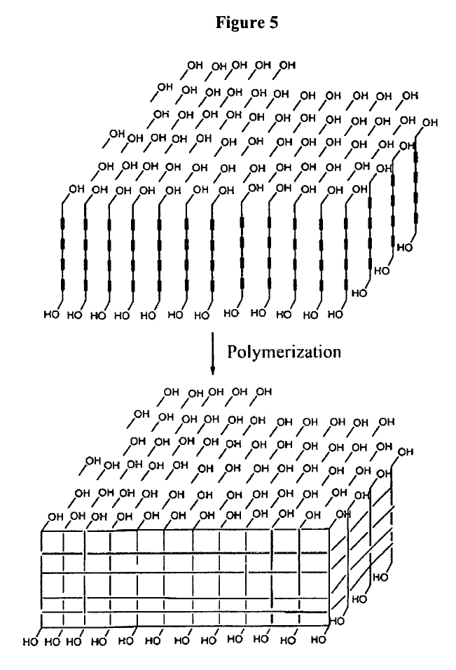

DHMOTY is also an amphiphilic compound due to the presence of two hydroxyl groups in the molecule. DHMOTY can be readily dispersed in water by introducing the solution of DHMOTY in THF into an excess amount of water. Ultrathin crystalline films of DHMOTY, thus, are formed and suspended in the aqueous solution. The ultrathin crystalline films gradually change into ultrathin polymer films at room temperature due to the spontaneous polymerization of octatetraynes. This is directly observable because the color of the ultrathin crystalline films shifts from colorless to blue, to dark-blue, and finally to black. The color changes are the result of the formation and growth of long-scale π-π conjugate structures as the polymerization continues. The micrographs of an ultrathin polymer film of polyDHMOTY are presented in FIG. 3. The powder X-ray diffraction spectrum of polyDHMOTY ultrathin films showed a strong peak at a low angle (2θ=7.76°, FIG. 4), corresponding to a distance of 11.34 Å between scattering planes. This distance is consistent with the length of DHMOTY molecules,^{31b} indicating that DHMOTY molecules are packed next to each other with hydroxyl groups stretching in water and further polymerized to form ultrathin polymer films (FIG. 5).

Moreover, polyDHMOTY nanospheres with number average diameters (Dn) of 91 and 256 nm can be obtained when DHMOTY in water at the concentration of 0.1% and 0.2% (wt.), respectively, is heated to temperatures above 65° C. This is most likely due to the melting of the ultrathin crystalline films of DHMOTY into liquid nanodroplets. As the reaction temperature increases above the melting point of the crystalline films the liquid nanodroplets polymerize into polyDHMOTY nanospheres. The exact melting point is not available due to the instability of DHMOTY. When the higher concentrations of DHMOTY (over 0.2%) were used, only small amount of nanospheres was obtained, accompanied by a large amount of polyDHMOTY precipitation occurring in the mixture.

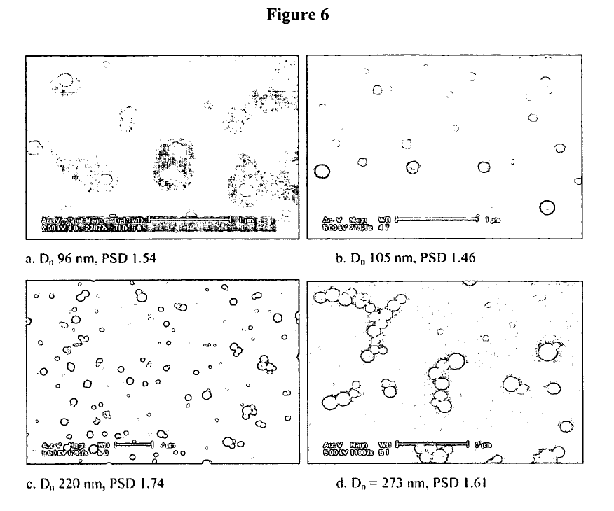

The addition of a small amount of an ionizable surfactant, e.g., phenyltrimethylammonium hydroxide, decreased the aggregation of nanoparticles effectively. The reason may be due to the fact that the quaternary ammonium ions may be absorbed on the surface of poly(1,8-hydroxymethyl-1,3,5,7-octatetrayne) nanoparticles behaving like a surfactant, thus introducing static-electric interactions among the nanoparticles in aqueous solutions. Therefore, polyDHMOTY nanospheres with average diameters of 96, 105, 220, and 273 nm (FIG. 6) were obtained at concentrations up to 0.4% of the monomer. The polydispersity index of the particle size distributions (PSD, Dw/Dn) was also determined. The PSD for all four samples was <2.0. The black areas around polyDHMOTY nanospheres in SEM images were formed by the residue of phenyltrimethylammonium hydroxide and can be removed when the particle solutions are concentrated and rinsed with ethanol. The optimal concentration of phenyltrimethylammonium hydroxide was found in the range of 0.01˜0.06 wt %, and changing the concentration of phenyltrimethylammonium hydroxide in this range only slightly affected the size of polyDHMOTY nanospheres. When a higher concentration of phenyltrimethylammonium hydroxide was used, flocculation of polymer nanospheres occurred again.

XPS measurements (Table 1) show that a large amount of hydroxyl groups exist on the surface of cross-linked polyDHMOTY nanospheres, as 44.4% C—OH units were observed in high-resolution C1s XPS spectra.^{32,33} This explains well why the polyDHMOTY nanosphere solids are redispersible in water. Bulk polymerization of DHMOTY also was performed. Interestingly, polyDHMOTY obtained from bulk polymerization of DHMOTY behaves like a hydrophobic polymer and cannot be dispersed in water. The hydroxyl groups on the surface of polyDHMOTY nanospheres offer the possibility to further modify polyDHMOTY nanospheres.

TABLE 1
Qualitative and Quantitative XPS Analyses of PolyDHMOTY
Nanospheres and the Corresponding Carbon Nanospheres^{32.33}

| | PolyDHMOTY | | | Carbon Nanospheres | | |
|---|---|---|---|---|---|---|
| | binding | | | binding | | |
| | energy/eV | assignment | % | energy/eV | assignment | % |
| C₁ | 284.73 | C═C | 45.9 | 284.53 | C═C | 66.5 |
| C₂ | 286.30 | C—OH | 44.4 | 285.60 | CH | 10.6 |
| C₃ | 288.16 | C═O | 9.7 | 286.23 | C—OH | 6.9 |
| | | | | 287.71 | C═O | 5.4 |
| | | | | 290.31 | Shake-up | 10.6 |
| O₁ | 532.05 | C═O | 12.2 | 532.28 | C═O | 43.4 |
| O₂ | 533.15 | C—OH | 81.8 | 533.12 | C—OH | 56.6 |

In addition, carbon nanospheres were produced in the yield of approximately 60% by pyrolysis of polyDHMOTY nanospheres at high temperatures. The carbon nanosphere yield is in agreement with the thermal gravimetric analysis (TGA). TGA experiment shows that the weight loss of polyDHMOTY nanospheres stopped at temperatures above 550° C., with the total weight loss of approximately 39%. This amount of weight loss (39%) is equal to the amount of hydroxymethyl groups in the molecule of DHMOTY, indicating that only the structures formed by octatetrayne units remained as carbonaceous materials and most of hydroxymethyl groups were volatilized in the pyrolysis.

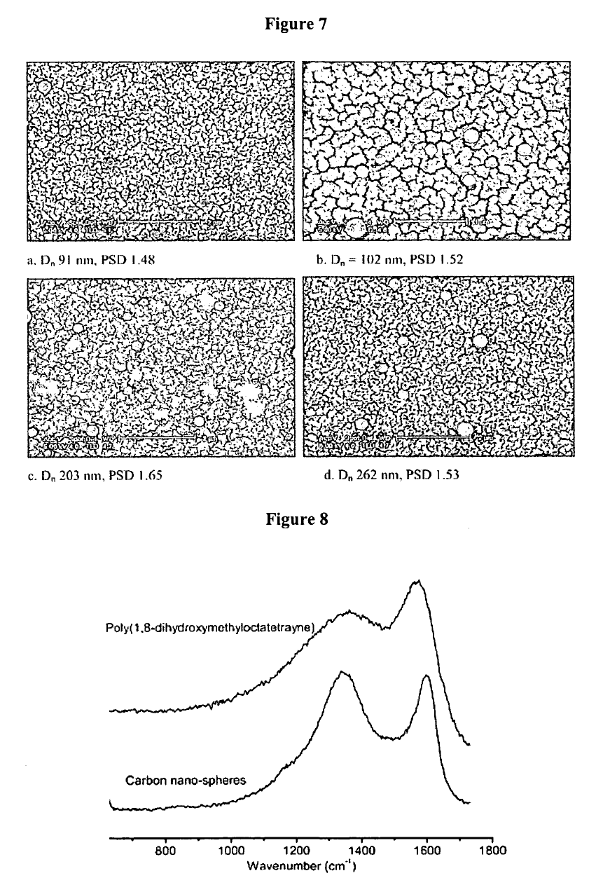

Carbon nanospheres formed by pyrolysis are shown in FIG. 7. The sizes and size distributions of carbon nano-spheres were comparable with their corresponding polymer nanospheres shown in FIG. 6.

Raman spectra of both polyDHMOTY nanospheres and carbon nanospheres are shown in FIG. 8. The Raman spectrum of polyDHMOTY nanospheres consists of two strong and broad peaks at 1363 and 1582 cm⁻¹, which is very similar to the spectrum of the sp² carbon-bonded amorphous carbon.³⁴ This result demonstrates the structural similarity between polyDHMOTY and the sp² carbon-bonded amorphous carbon. The XPS data confirm the similarity in that 46% of carbon in polyDHMOTY was found to be involved in carbon-carbon double bonds (Table 1). The Raman spectrum of carbonized polyDHMOTY or carbon nanospheres is the same as that of glassy carbon or microcrystalline graphite with two peaks, a 1590 cm⁻¹ peak denoted the G peak, and a second peak around 1350 cm⁻¹ denoted the D peak which is a disorder-activated zoneboundary mode.³³

### EXAMPLE 4

Preparation of Polymer Microbeads Materials. 1-Hexyne, 2-(trimethylsilyl) acetylene, N,N,N,N-tetramethylethylenediamine (TMEDA), iodine, n-butyllithium (2.0 M in pentane), bis(triphenylphosphine)palladium(II) dichloride, copper(I) iodide, copper(II) acetate monohydrate, di-(iso-propyl)-amine, poly(vinyl alcohol) (87-89% hydrolyzed, average Mw 31 000-50 000) were used as received from Aldrich. 1-Iodo-2-(trimethylsilyl) acetylene was prepared using a literature procedure.¹⁶

Preparation of 1-Butyl-4-(trimethylsilyl)-1,3-butadiyne. To 90 mL of diisopropyleneamine were added bis(triphenylphosphine)-palladium(II) dichloride (0.21 g, 0.31 mmol) and copper(I) iodide 0.058 g, 0.31 mmol). The mixture was stirred and degassed with a stream of argon, and a mixture of 1-hexyne (1.0 g, 12.2 mmol) and 1-iodo-2-(trimethylsilyl) acetylene (2.73 g, 12.2 mmol) was added. The solution was stirred at room temperature for 2.5 h; a heavy precipitate formed during this period of time. The reaction mixture was filtered to remove salts. The filtrate was concentrated with a rotary evaporator under vacuum and the oily residue was obtained. The crude product was purified by passing it through a silica gel column with hexane as the eluent. The pure product was obtained as a yellow liquid at the yield of 89% (1.94 g). ¹H NMR (250 MHz, CDCl₃): δ 0.16(9H), 0.88(3H), 1.39 (2H), 2.24(2H).13C NMR (63 MHz, CDCl₃): δ-0.47, 13.40, 18.79, 21.83, 30.11, 65.49, 79.84, 82.58, 88.56. IR 2552, 2527, 2492, 2464, 1936, 1789, 1671, 1628, 1003, 962, 914, 857, 780, 709, 629 cm⁻¹.

Preparation of 1-Butyl-1,3-butadiyne. To a solution of 1-butyl-4-(trimethylsilyl)-1,3-butadiyne (4.0 g, 22.4 mmol) prepared above in methanol (65 mL), was added a 5% aqueous solution of potassium hydroxide (2.4 mL). The solution was stirred at room temperature for 2 h. The reaction mixture was diluted with an equal volume of water, and extracted with n-pentane (4×50 mL). The combined organic layers were dried over MgSO₄ and the solvent was removed under reduced pressure to yield a yellow liquid. The product was purified using a silica gel column with n-pentane as the eluent and yielded 1-butyl-1,3-butadiyne as a yellow liquid (2.10 g, 90%). ¹H NMR (250 MHz, CDCl₃): δ 0.87 (3H), 1.44(4H), 1.91(1H), 2.19(2H). ¹³C NMR (63 MHz, CDCl₃): δ 13.87, 19.25, 22.30, 30.80, 64.76, 65.69, 68.88, 78.80. IR 2959, 2934, 2224, 1466, 1427, 1252, 1054, 846, 620 cm⁻¹.

Preparation 1,8-Dibutyl-1,3,5,7-octatetrayne. A solution of acetone (50 mL), TMEDA (0.54 g, 4.5 mmol), and copper(II) acetate monohydrate (0.29 g, 1.50 mmol) was stirred at room temperature. Air was introduced into the solution with an inlet tube immersed in the solution. To the solution 1-butyl-1,3-butadiyne (2.0 g, 18.9 mmol) was added. The reaction mixture was stirred at room temperature for about 2 h until TLC indicated that the reaction was completed. The reaction mixture was poured into a beaker containing both a 5% HCl aqueous solution (45 mL) and hexane (45 mL). The organic layer was collected and the aqueous solution was extracted with hexane (3×40 mL). The combined organic layers were dried over MgSO₄ and concentrated under reduced pressure leaving a yellow liquid as the crude product. The crude product was purified using a silica gel column with hexane as the eluent and yielded 1,8-dibutyl-1,3,5,7-octatetrayne as a yellow liquid (1.82 g, 91%). ¹H NMR (200 MHz, CDCl₃): δ 0.80(6H), 1.42(8H), 2.22-(4H). ¹³C NMR (63 MHz, CDCl₃): δ 13.83, 19.22, 22.36, 30.84, 60.90, 61.76, 66.07, 80.75. IR 2960, 2935, 2874, 2226, 1466, 1425, 1380, 1322, 1249, 1105, 740, 618 cm⁻¹.

Suspension Polymerization of Dibutyloctatetrayne. Poly(1,8-dibutyloctatetrayne) microbeads were prepared by suspension polymerization using water as the continuous phase. Typically, deionized water (8.0 mL) and 2% (w/w) PVA/H₂O (3.0 g) were placed in a reactor equipped with a mechanical motor. 1,8-Dibutyloctatetrayne (2.0 g) was added to the mixture. The mixture was heated to 80° C. using an oil bath. The mechanical motor was turned on, and the stirring speed was gradually increased and fixed at the level at which the desired size of droplets was achieved. The heating and stirring were continued for 48 h. The beads formed in the aqueous solution were filtered and washed with deionized water. The beads were dried in oven at 95° C. and 1.52 g (76%) of black beads was obtained.

### EXAMPLE 5

Preparation of Carbon Microspheres. The cross-linked polydibutyloctatetrayne beads (0.50 g) prepared above were placed in a quartz tube furnace and gradually heated to 800° C. (heating rate 1° C./min) under nitrogen atmosphere and held at 800° C. for 24 h. After cooling to room temperature, 0.25 (50%) g of carbon microbeads was obtained from the quartz tube.

### EXAMPLE 6

Analysis of Carbon Microbeads All NMR spectra were recorded on a Bruker AC-200. FTIR spectra were obtained with a Perkin-Elmer 1600 FTIR spectrometer. KBr and polymer samples were thoroughly mixed, and the mixture was pressed to form a pellet, then the spectra were recorded. Raman spectra were recorded on a Spex 1403 double monochromator, a RCA 31034A photomultiplier, and a 514.5-nm laser with ca. 50 mW. Microscopic images of polydibutyloctatetrayne beads and carbon beads were obtained from a Sirion scanning electron microscope. Numeric average particle diameters (Dn), weight average particle diameters (Dw), and polydispersity index of particle size distribution (PSD, Dw/Dn) were determined based on the diameters of more than 100 particles in SEM images. TGA analyses were carried out on a TA Instruments TGA 2050 thermogravimetric analyzer. XPS was conducted on a Kratos AXIS ultra. The XPS data were processed using Kratos Vision Processing. Powder X-ray diffraction was conducted on a Rigaku Geigerflex X-ray Powder Diffractometer with Cu KR line (0.154 nm) as the incident beam. A Micromeritics ASAP 2020 surface area and porosity analyzer was used to measure the surface areas and average pore sizes of the particles.

The synthetic pathway used to produce the monomer, 1,8-dibutyl-1,3,5,7-octatetrayne, is illustrated in Scheme 2. 1-Hexyne was reacted with 1-iodo-2-(trimethylsilyl)acetylene using palladium and copper catalysts in diisopropylamine to produce 1-butyl-4-(trimethylsilyl)-1,3-butadiyne. The trimethylsilyl protecting groups were removed in quantitative yield by treatment with a catalytic quantity of potassium hydroxide in aqueous methanol to yield 1-butyl-1,3-butadiyne. The oxidative coupling reaction of 1-butyl-1,3-butadiyne using oxygen and copper(II) acetate monohydrate in acetone provided the liquid products 1,8-dibutyl-1,3,5,7-octatetrayne. Note that all the intermediates in Scheme 1, including the final product, 1,8-dibutyl-1,3,5,7-octatetrayne, are stable at room temperature and can be separated in the pure state. The 1,8-dibutyl-1,3,5,7-octatetrayne may be polymerized below 90° C.; accordingly, the liquid monomer is converted to the insoluble dark-brown solid polymer. To obtain FTIR spectra of the products, the polymerization reactions were conducted in sealed vials. The vials of the dibutyloctatetrayne monomer were placed in an oven at a specific temperature for 24 h. IR spectra of 1,8-dibutyl-1,3,5,7-octatetrayne and its corresponding polymerization products at temperature ranging from 70 to 95° C. showed that the intensity of the peaks at 2226 cm⁻¹, which are attributed to the —C≡C— skeleton stretching vibrations, decreases and almost disappears as the reaction continues. Quantitative XPS data shown in Table 2 confirm this result by showing that no carbon atom from —C≡C— is observed and 38.2% carbon atoms in the form of C═C are detected on the surface of poly(1,8-dibutyl-1,3,5,7-octatetrayne) microbeads.

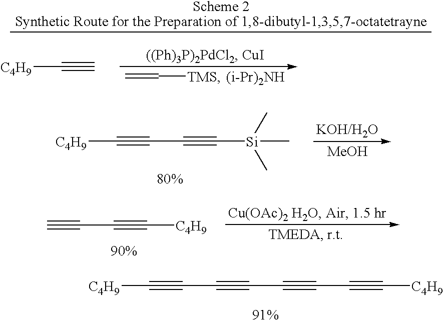

TABLE 2
Results of Qualitative and Quantitative XPS
Analysis of Poly(dibutyloctatetrayne) Beads and the
Correspondent Carbon Beads

| Poly(dibutyloctatetrayne) | | | Carbon Beads | | |
|---|---|---|---|---|---|
| binding | | | binding | | |
| energy/eV | assignment | % | energy/eV | assignment | % |
| C₁ 284.67 | C═C | 38.2 | 284.50 | C═C | 79.9 |
| C₂ 285.31 | CH₂, CH₃ | 38.4 | 285.35 | CH₂, CH₃ | 14.4 |
| C₃ 286.54 | C—OH | 16.7 | 286.36 | C—OH | 4.7 |
| C₄ 288.06 | C═O | 6.8 | 287.78 | C═O | 2.0 |
| O₁ 532.09 | C═O | 28.5 | 531.98 | C═O | 30.6 |
| O₂ 532.94 | C—OH | 71.5 | 532.90 | C—OH | 69.4 |

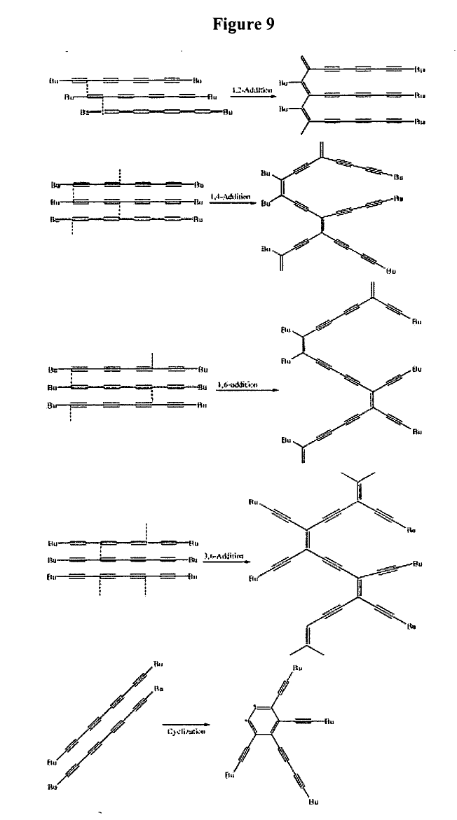

Therefore, it may be surmised that the main reactions for the polymerization involve the conversion of sp¹-hybridized carbon atoms in the molecule of 1,8-dibutyl-1,3,5,7-octatetrayne into sp²-hybridized carbon atoms by a variety of triple bond additions (Scheme, FIG. 9) including [4+2] cycloaddition²² and any further cyclizations^{20,23} to form graphite-like structures.

The unique properties of 1,8-dibutyl-1,3,5,7-octatetrayne, such as self-polymerizability at 70-90° C. of the liquid state, and stability in water, provided the possibility to perform suspension polymerization of 1,8-dibutyl-1,3,5,7-octatetrayne in aqueous solution similar to that for vinyl monomer suspension polymerization.

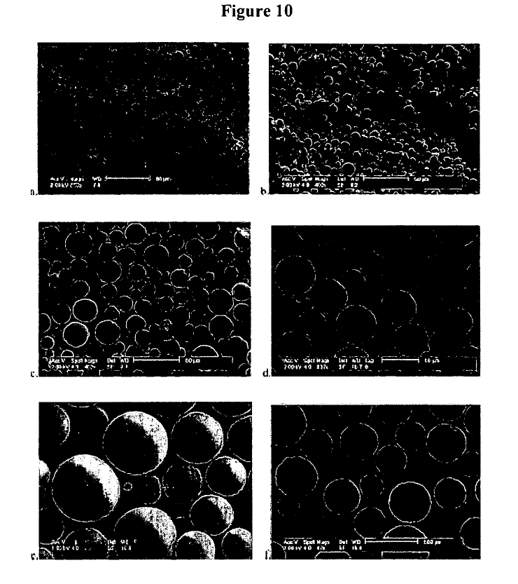

The suspension polymerizations of 1,8-dibutyl-1,3,5,7-octatetrayne were conducted under conditions similar to those of suspension polymerizations for vinyl monomers by using water as the continuous phase and poly(vinyl alcohol) as the stabilizer,²⁴ and accordingly cross-linked poly(1,8-dibutyl-1,3,5,7-octatetrayne) microbeads were obtained. The results of 1,8-dibutyl-1,3,5,7-octatetrayne suspension polymerization are illustrated in FIG. 10 and Table 3. Cross-linked poly-(1,8-dibutyl-1,3,5,7-octatetrayne) microbeads with various diameters ranging from hundreds of micrometers to a few micrometers were obtained by adjusting the concentration of the stabilizer, poly(vinyl alcohol), in the continuous phase and the stirring rate of the motor. As shown in Table 3, the average diameters of poly(1,8-dibutyl-1,3,5,7-octatetrayne) microbeads decrease by increasing the stabilizer's concentration in aqueous solution. Because some of the monomer was emulsified in aqueous solutions, and also some of poly(1,8-dibutyl-1,3,5,7-octatetrayne) adhered to the surface of the stirrer during the polymerization, the yields of poly(1,8-dibutyl-1,3,5,7-octatetrayne) microbeads were in the range of 71-76%. The same phenomenon also occurred in the suspension polymerizations of vinyl monomers.²⁴ The polydispersity index listed in Table 3 indicates that poly(1,8-dibutyl-1,3,5,7-octatetrayne) microbeads size distributions are broad, which is also similar to the results of vinyl monomer suspension polymerization.

TABLE 3
Conditions and Results of Suspension Polymerization of 1,8-Dibutyloctatetrayne

| | | | PDBO | | Carbon Beads | | | | |
|---|---|---|---|---|---|---|---|---|---|
| | polymerization | yield | dₙ | | dₙ | | SA_{BET}^{a} | PS_{BET}^{a} | |
| no. | conditions | (%) | (mm) | PSD | (mm) | PSD | (m²/g) | (nm) | FIGS. |
| 1 | 1% PVA: 640 rpm | 71 | 2.52 | 2.68 | 1.43 | 2.57 | 611 | 1.5 | 2a, 4a |
| 2 | 0.8% PVA: 500 rpm | 72 | 5.19 | 2.00 | 3.74 | 2.01 | | | 2b, 4b |
| 3 | 0.5% PVA: 380 rpm | 74 | 15.1 | 1.47 | 12.5 | 1.58 | | | 2c, 4c |
| 4 | 0.4% PVA: 300 rpm | 76 | 37.5 | 1.60 | 27.2 | 1.54 | | | 2d, 4d |
| 5 | 0.2% PVA: 380 rpm | 75 | 46.9 | 1.62 | 41.9 | 1.51 | 1.76 | 1.8 | 2e, 4e |
| 6 | 0.1% PVA: 300 rpm | 71 | 316 | 1.78 | 240 | 1.83 | | | 2f, 4f |

^{a}SA_{BET}, surface area by BET; PS_{BET}, pore size by BET.

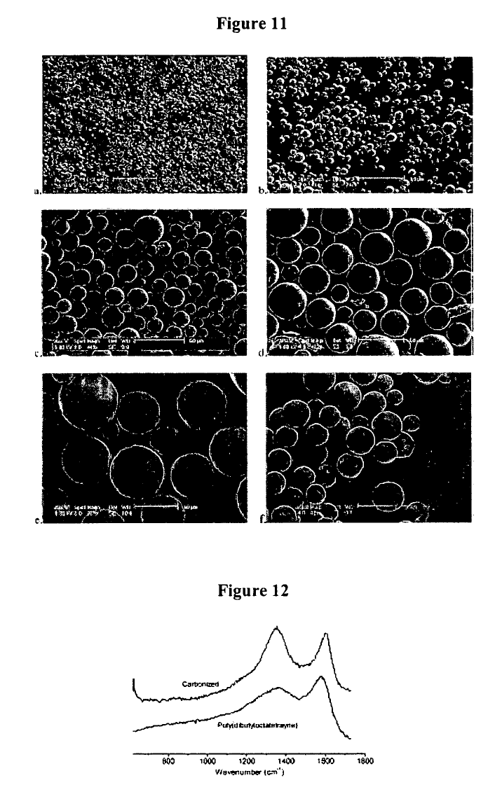

The cross-linked poly(1,8-dibutyl-1,3,5,7-octatetrayne) microbeads may further be converted to carbon microbeads by pyrolysis at high temperature under an inert atmosphere. The temperature was gradually increased at the rate of 10° C./min from room temperature to above 800° C. in nitrogen. Weight loss of poly(1,8-dibutyl-1,3,5,7-octatetrayne) stopped when the temperature reached 800° C. and the total weight loss was approximately 50% in the whole process of carbonization. This result may indicate that only the structures formed by octatetrayne units remained as carbon materials and most of the butyl groups were volatized in the course of the pyrolysis. The weight percentage lost does correspond to the weight proportion of the polymer due to the butyl groups. The carbon beads formed by pyrolysis are shown in FIG. 11.

The sizes and polydispersity indexes of carbon microbeads are listed in Table 3. The carbonized products shrank compared with the original microbeads of poly(1,8-dibutyl-1,3,5,7-octatetrayne). However, the polydispersity index of carbon beads did not change and the beads still maintained their spherical shape despite the nearly 50% weight loss. The carbon microbeads are easily dispersible in various organic solvents, indicating that no aggregation occurred in the pyrolysis and most of the carbon microbeads kept the shape of a single bead. This behavior is different from the production of mesoporous micrbeads, MCMB, and can be ascribed to the cross-linked structures of poly(dibutyloctatetrayne) beads. It is known that MCMB, formed by stacking or aggregation of polyaromatic molecules, are fusible when the temperature is higher than the one at which MCMB were prepared which is typically 350-500° C. The mechanical strength of the carbon beads was demonstrated by placing the beads in a sealed tank where 272 atm pressure was applied for 24 h. SEM images of the beads showed that no changes in the size or shape occurred.

The Brunauer-Emmett-Teller (BET) surface areas and average pore sizes for two samples of carbon beads were measured (Table 3). The small particles (diameter 2 μm) have very high surface areas. These surface areas are comparable to those obtained in carbon aerogels.²⁵ However, the largest carbon particles (diameter 316 μm) have very low surface areas but have average pore sizes similar to those found in the small particles. More studies are underway to attempt to control the surface area of the particles through the polymerization reaction conditions.

Raman spectra of both poly(1,8-dibutyl-1,3,5,7-octatetrayne) and carbon microbeads are compared in FIG. 12. The Raman spectra of poly(1,8-dibutyl-1,3,5,7-octatetrayne) and the carbon microbeads consist of two strong and broad peaks at 1363 and 1582 cm⁻¹. The band near 1582 cm⁻¹ is the E₂G fundamental. This band is indicative of the creation of an sp²-hybridized carbon structure.²⁶⁻²⁸ The 1363 cm⁻¹ only occurs in disordered carbons and is typically attributed to in-plane disorder. The in-plane microcrystallite size, L_{α}, can be estimated using Knight's empirical formula, L_{α}=44−(I₁₅₈₀/I₁₃₆₀).²⁷ The order of magnitude of L_{α} is believed to probe the dimension of the sp² ribbons that make up the amorphous particles. The L_{α} value of the carbon beads is 4.7 nm which is comparable to values observed for other disordered carbons such as aerogels and glassy carbons.²⁹ The significant broadening of two Raman bands is also typical of carbon materials with small microcrystallite size. The bands tend to broaden as the microcrystallite size decreases.²⁷ These results conclusively confirm the structural similarity between poly(dibutyloctatetrayne) and the sp² carbon-bonded amorphous carbon, and also confirm the results of the XPS and IR experiments.

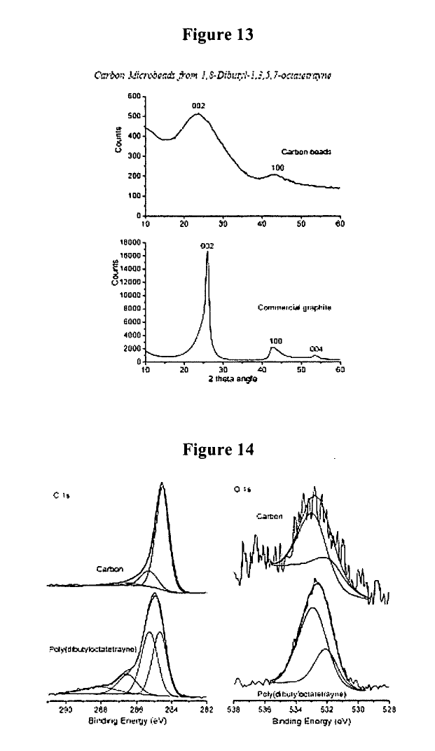

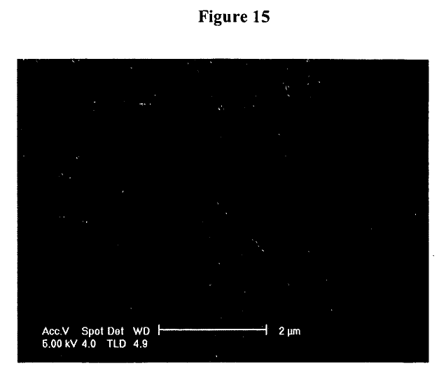

The X-ray diffraction patterns of commercial graphite and carbon beads are presented in FIG. 13. The commercial graphite has three peaks in the range of 2θ) 10-60° for the planes (002), (100), and (004) at 26.34°, 43.01°, and 53.86°, respectively.³⁰ Carbon beads have two broad peaks at 23.78° and 43.29° this range, which further confirms the existence of graphitic crystallites in the structures. However, the position for plane (002) in the carbon beads shifts to a low value (23.78°) compared to that of the commercial graphite (26.34°). The interplanar distance d in carbon beads according to the Bragg's law is larger than that in the commercial graphite, which demonstrates that the amorphous structures disorder the crystal structures.

X-ray photoelectron spectra of poly(dibutyloctatetrayne) beads and carbon microbeads were also recorded. Wide scan XPS shows the presence of oxygen electron at 532.6 eV in both cases. Oxygen atoms in the spectra evidently are from poly(vinyl alcohol) which was used as the stabilizer for suspension polymerization. Although most of poly(vinyl alcohol) was removed by washing the beads with water, there may still be a small amount of poly(vinyl alcohol) absorbed on the surface of the beads which resulted in a strong peak in the XPS spectrum. In contrast, the intensity of oxygen peak in the spectrum of carbonized beads is much weaker due to the carbonization. High-resolution C1s and O1s spectra are shown in FIG. 14. The components obtained from curve-fitting are also plotted.^{31,32} Detailed results for each component are collected in Table 2. Four different carbon species, including CdC, CH₂/CH₃, CsOH, and CdO, were observed in both spectra, where CdO is from partially hydrolyzed poly(vinyl alcohol). It can be seen that sp²-hybridized carbon atoms become the main component in carbon beads and the amount of other carbon species in carbon beads decreases dramatically as the result of pyrolysis. O1s XPS spectra confirm the results from C1s XP spectra. As shown in Table 2, the binding energy and percentage ratios for O1s components are in agreement with the assignments made for carbon species.

### EXAMPLE 7

Preparation 5,7,9,11 hexadecatetraydoic acid (HDTDA) was also synthesized. HDTDA is stable in solution and polymerizable at room temperature via C—C triple bond addition with the triple bonds stacking close together (which is very similar to the behavior of dihydroxymethyloctatetryne). Interestingly, this material is crystallized and polymerized after dissolving it in warm NaOH. The original nanocrystalline structures still remain after polymerization. Nanocrystals have been widely observed in inorganic materials. However, nanospheres and nanofibers are not typically produced with organic polymer systems. This polymer is also very interesting to us due to its strong difference in polarity between the backbone and one of the end groups. This polymer, like DHMOTY, is self-assembling, and self polymerizing. The ordering nature of these polymer allows unique structures to be formed.

Materials. 1-Dodecyne, 1-iodo-2-(trimethylsilyl)acetylene, 5-hexynoic acid, lithium hydroxide, bis(triphenylphosphine)palladium (II) dichloride, copper(II) acetate hydrate, hydroxylamine chloride, p-toluenesulfonic acid, copper(I) chloride, diethyl amine, NBS, silver nitrate, diisopropyleneamine and 5-hexynoic acid were used as received from Aldrich.

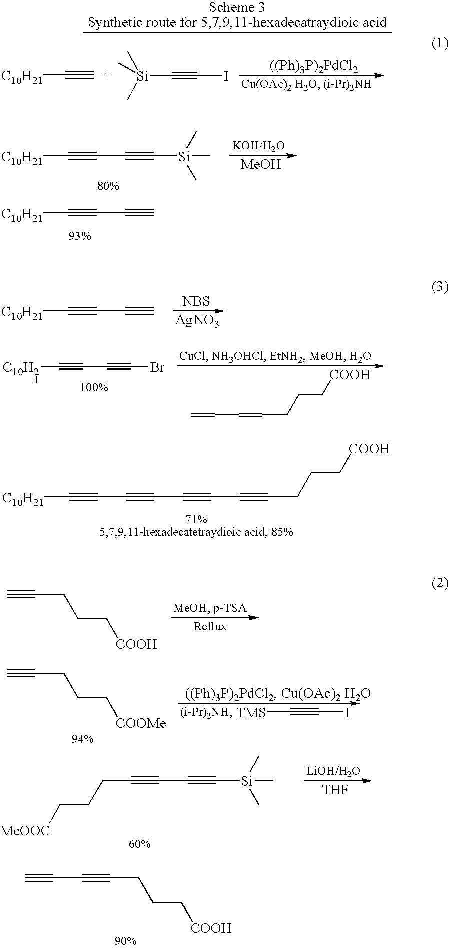

Preparation of 1decyl-4-(trimethylsilyl)-1,3-tetradecadiyne To 250 mL of diisopropyleneamine were added bis(triphenylphosphine)palladium (II) dichloride (0.56 g), copper(II) acetate monohydrate (0.16 g). The mixture was stirred and degassed with a stream of argon and a mixture of 1-dodecyne (8.0 g) and 1-iodo-trimethylsilyl acetylene (10.8) were added. The solution was stirred at room temperature for 3 h and a heavy precipitation was formed during this period of time. The reaction mixture was filtered to remove salts. The filtrate was concentrated with a rotary evaporator under vacuum and the oily residue was obtained. The crude product was purified by passing a silica gel column with hexane as eluent. The pure product was obtained as a yellow liquid at the yield of 80% (10.1 g).

Preparation of 1-decyl-1,3-tetradecadiyne To a solution of 1-dectyl-4-(trimethylsilyl)-1,3-butadiyne (1.15 g) prepared above in methanol (11 mL), was added 3 mL THF and 5% aqueous solution of potassium hydroxide (0.5 mL). The solution was stirred at room temperature for 3 h. The reaction mixture was diluted with equal volume of water, and extracted with hexane (3×30 mL). The combined organic layers were dried over MgSO4 and the solvent was removed under reduced pressure to yield a yellow liquid. The product was purified by silica gel column with hexane as the eluent and yielded 1-decyl-1,3-butadiyne as a yellow liquid (0.77 g, 93%).

Preparation of methyl 5-hexynoate 5-Hexynoic acid 3.2 g and p-toluenesulfonic acid 64 mg were mixed and refluxed in methanol (19 mL) for 4 h. The mixture was then poured into saturated NaCl aqueous solution and extracted with diethyl ether three times. All ether layers were combined, dried over anhydrous MgSO4 and concentrated to give 3.38 g colorless liquid (yield 94%).

Preparation of methyl 8-(trimethylsilyl)-5,7-octadiynoate To 200 mL of diisopropyleneamine were added bis(triphenylphosphine)palladium (II) dichloride (0.436 g), copper(II) acetate monohydrate (0.124 g). The mixture was stirred and degassed with a stream of argon and a mixture of methyl 5-hexynoate (4.7 g) and 1-iodo-trimethylsilyl acetylene (8.35 g) were added. The solution was stirred at room temperature for 3 h and a heavy precipitation was formed during this period of time. The reaction mixture was filtered to remove salts. The filtrate was concentrated with a rotary evaporator under vacuum and the oily residue was obtained. The crude product was purified by passing a silica gel column with 10% acetate/hexane as eluent. The pure product was obtained as a yellow liquid at the yield of 60% (4.97 g).

Preparation of 5,7-octadiynoic acid To a solution of methyl 8-(trimethylsilyl)-5,7-octadiynoate (3.2 g) prepared above in THF (6 mL), was added 1M aqueous solution of lithium hydroxide (4.5 mL). The solution was stirred at room temperature for 4 h. The reaction mixture was diluted with equal volume of 15% HCl aqueous solution, and extracted with diethyl ether (3□200 mL). The combined organic layers were dried over MgSO4. and the solvent was removed under reduced pressure to yield a yellow liquid. The product was purified by silica gel column with 10% MeOH/DCM as the eluent and give 1.76 g (90%) 5,7-octadiynoic acid.

Preparation of 1-bromo-4-octyl-1,3-tetrayne 1-decyl-1,3-tetrayne (4.0 g) and NBS (4.12 g) were mixed in acetone (120 mL) and then 0.36 g of AgNO₃ was added. The mixture was stirred at room temperature for 4 h and then poured into water, extracted with hexane for three times. The combined organic layers were dried over MgSO₄ and hexane was removed under reduced pressure to give light yellow liquid for next step synthesis without purification. The yield is almost 100%.

Preparation of 5,7,9,11-hexadecatetraydioic acid CuCl (0.1683 g) and hydroxylamine chloride (0.0365 g) were dissolved in the mixed solution of 70% Et₂NH₂ (5.6 mL), MeOH (5 mL) and Water (2.1 mL), then 0.9255 g of 5,7-octadiynoic acid was carefully added into the solution in ice-water bath. The ice-water bath was change to cool water bath, and 1.9 g of 1-bromo-4-octyl-1,3-tetrayne in 2 mL methanol was added dropwisely in 1 h. The mixture was continuously stirred at room temperature for 3 h, and then diluted with 20 mL ethyl acetate and poured into 30 mL 15% HCl aqueous solution. The organic layer was separated and the aqueous phase was extracted with ethyl acetate (20 mL) for two times. The combined organic layers were dried over MgSO₄ and concentrated. The product was purified by silica gel column with 40% acetate/hexane as the eluent and give the final product as colorless crystal (1.56 g, 71%). The compound in solid state is not stable and should be stored as THF solution in refrigerator.

The examples described herein are for illustrative purposes and are not meant to limit the scope of the invention.

The invention claimed is:

1. A micro or nano polymeric material formed from a polymerized oligoyne, polyyne or mixture thereof.

2. The material of claim 1 wherein polymeric material is formed from an end-capped tetrayne.

3. The material of claim 1 wherein the tetrayne is end-capped with an end-capping unit selected from alkyl, alkyl hydroxyl, carboxylic acids, and combinations thereof.

4. The material of claim 3 wherein the end-capping unit is selected from the group consisting of methyl, ethyl, propyl, butyl, pentyl, methyl hydroxyl, ethyl hydroxyl, propyl hydroxyl, carboxylic acids, and combinations thereof.

5. The material of claim 3 wherein the end-capped tetrayne is an end-capped octatetrayne.

6. The material of claim 5 wherein the end-capped tetrayne is amphiphilic.

7. The material of claim 6 wherein the end-capped tetrayne is 1,8-dihydroxymethyl-1,3,5,7-octatetrayne.

8. The material of claim 3 wherein the end-capped tetrayne is 1,8-dibutyl-1,3,5,7-octatetrayne.

9. The material of claim 3 wherein the end-capped tetrayne is 5,7,9,11 hexadecatetraydoic acid or a salt thereof.

10. A method for making a polymeric nanomaterial comprising
a) dispersing a self-polymerizable monomer selected from the group consisting of an oligoyne, a polyyne or mixtures thereof in a solvent; and
b) causing the self-polymerizable monomer to polymerize thereby forming the polymeric nanomaterial.

11. The method of claim 10 wherein the self-polymerizable monomer comprise an end-capped tetrayne.

12. The method of claim 11 wherein the tetrayne is end-capped with an end-capping unit selected from alkyl, alkyl hydroxyl, carboxylic acids, and combinations thereof.

13. The method of claim 12 wherein the end-capping units are selected from the group consisting of methyl, ethyl, propyl, butyl, pentyl, methyl hydroxyl, ethyl hydroxyl, propyl hydroxyl and combinations thereof.

14. The method of claim 12 wherein the end-capped tetrayne is 1,8-dihydroxymethyl-1,3,5,7-octatetrayne.

15. The method of claim 12 wherein the end-capped tetrayne is 1,8-dibutyl-1,3,5,7-octatetrayne.

16. The method of claim 12 wherein the end-capped tetrayne is 5,7,9,11 hexadecatetraydoic acid.

17. The method of claim 10 further comprising
c) pyrolizing the polymer nanomaterial to yield a carbon nanomaterial.

18. The method of claim 17 wherein the carbon nanomaterial comprises carbon nanospheres carbon microspheres or carbon fibers.

19. The method of claim 12 wherein the polymeric nanomaterial comprises a film.

20. The method of claim 19 wherein the film is a molecularly thin film.

21. The method of claim 12 wherein the polymeric material comprises polymeric nanocrystals.

22. A method for preparing a molecularly organized layer on a surface comprising
a) contacting a surface with a self-assembling, self-polymerizable monomer; and
b) polymerizing the self-assembling, self-polymerizable monomer to form a polymeric film that is molecularly thin.

23. The method of claim 22 wherein monomer is an end-capped tetrayne.

22. The method of claim 23 wherein the tetrayne is end-capped with an end-capping unit selected from alkyl, alkyl hydroxyl, carboxylic acids, and combinations thereof.

25. The method of claim 22 wherein the end-capping units are selected from the group consisting of methyl, ethyl, propyl, butyl, pentyl, methyl hydroxyl, ethyl hydroxyl, propyl hydroxyl and combinations thereof.

26. The method of claim 23 wherein the end-capped tetrayne is an end-capped octatetrayne.

27. The method of claim 26 wherein the end-capped tetrayne is amphiphilic.

28. The method of claim 27 wherein the wherein the end-capped tetrayne is 1,8-dihydroxymethyl-1,3,5,7-octatetrayne.

29. A method for preparing polymer microbeads comprising
a) dispersing a self-polymerizable liquid end-capped tetrayne in a solvent; and
b) heating the self-polymerizable end-capped tetrayne to a temperature sufficient to form polymeric microbeads.

30. The method of claim 29 wherein the self-polymerizable liquid end-capped tetrayne is end-capped with an end-capping unit selected from the group consisting of alkyl, R₃Si—, and combinations thereof, wherein R is selected from the group consisting of H, methyl, ethyl, butyl and propyl.

31. The method of claim 30 wherein the self-polymerizable liquid end-capped tetrayne is an end-capped octatetrayne.

32. The method of claim 31 wherein the self-polymerizable liquid end-capped tetrayne is 1,8-dibutyl-1,3,5,7-octatetrayne.

33. The method of claim 32 further comprising pyrolizing the polymer microbeads to form carbon microbeads.

34. A high yield method for chemically synthesizing low polydispersivity carbon microspheres, nanospheres, nanocrystals, nanotubes, or nanofibers comprising
a) dispersing a self-polymerizing end-capped tetrayne in a solvent;
b) heating the dispersed self-polymerizing end-capped tetrayne to form a polymeric material selected from the group consisting of polymer microspheres, polymer nanospheres, polymer nanocrystals, polymer nanotubes, and polymer nanofibers; and
c) pyrolyzing the polymeric material to form a carbon material selected from the group consisting of carbon microspheres, carbon nanospheres, carbon nanocrystals carbon nanotubes, and carbon nanofibers;
wherein the polydispersivity of the carbon material is in the range from 1 to 2.

35. The method of claim 31 wherein the polydispersivity of the carbon material is in the range from 1.25 to 1.75.

36. The method of claim 35 wherein the polydispersivity of the carbon material is in the range from 1.45 to 1.65.

37. A micro- or nano-carbon material having a polydispersivity of less than 2.

38. The micro- or nano-carbon material of claim 37 wherein the polydispersivity is in the range from 1.25 to 1.85.

39. The micro- or nano-carbon material of claim 38 wherein the polydispersivity is in the range from 1.45 to 1.70.

40. The micro- or nano-carbon material of claim 37 wherein the micro- or nano-carbon material is selected from the group consisting of carbon microspheres, carbon nanospheres, carbon nanotubes, and carbon nanofibers.
